(19) United States
(12) Patent Application Publication
(10) Pub. No.: US 2014/0169676 A1
(43) Pub. Date: Jun. 19, 2014

(54) INFORMATION PROCESSING APPARATUS, INFORMATION PROCESSING METHOD, AND COMPUTER-READABLE MEDIUM

(71) Applicant: FUJI XEROX CO., LTD., Tokyo (JP)

(72) Inventor: Eiichi TANAKA, Kanagawa (JP)

(73) Assignee: FUJI XEROX CO., LTD., Tokyo (JP)

(21) Appl. No.: 13/893,698

(22) Filed: May 14, 2013

(30) Foreign Application Priority Data
Dec. 18, 2012 (JP) 2012-276018

(51) Int. Cl. G06K 9/18

(52) U.S. Cl. CPC G06K 9/18
USPC 382/189; 382/187

(57) ABSTRACT

An information processing apparatus includes a morphological analysis unit, a feature-value vector generation unit, and a degree-of-certainty calculation unit. The morphological analysis unit performs morphological analysis on a character recognition result. The feature-value vector generation unit generates a feature-value vector having elements, the number of which is P+1, for each character in the character recognition result. The feature-value vector includes part-of-speech likelihoods and a character similarity for the character in the character recognition result. The part-of-speech likelihoods correspond to P types of part of speech and are generated based on a probability of a part of speech of a word which includes the character and which is the result of the morphological analysis performed by the morphological analysis unit. The degree-of-certainty calculation unit calculates a degree of certainty for each character in the character recognition result from the feature-value vector generated by the feature-value vector generation unit.

### CROSS-REFERENCE TO RELATED APPLICATIONS

This application is based on and claims priority under 35 USC 119 from Japanese Patent Application No. 2012-276018 filed Dec. 18, 2012.

### BACKGROUND

### Technical Field

The present invention relates to an information processing apparatus, an information processing method, and a computer-readable medium.

### SUMMARY

The gist of the present invention is constructed as follows. According to an aspect of the invention, there is provided an information processing apparatus including a morphological analysis unit, a feature-value vector generation unit, and a degree-of-certainty calculation unit. The morphological analysis unit performs morphological analysis on a character recognition result. The feature-value vector generation unit generates a feature-value vector having elements, the number of which is P+1, for each character in the character recognition result. The feature-value vector includes part-of-speech likelihoods and a character similarity for the character in the character recognition result. The part-of-speech likelihoods correspond to P types of part of speech and are generated on the basis of a probability of a part of speech of a word which includes the character and which is the result of the morphological analysis performed by the morphological analysis unit. The degree-of-certainty calculation unit calculates a degree of certainty for each character in the character recognition result from the feature-value vector generated by the feature-value vector generation unit.

### BRIEF DESCRIPTION OF THE DRAWINGS

Exemplary embodiments of the present invention will be described in detail based on the following figures, wherein:

FIG. 1 is a conceptual diagram illustrating an exemplary module configuration of a first exemplary embodiment;

FIG. 2 is a diagram for describing an exemplary data structure of a correct-incorrect/character-similarity/part-of-speech table for a character recognition result;

FIG. 3 is a diagram for describing an exemplary data structure of a reference part-of-speech table;

FIG. 4 is a diagram for describing an exemplary data structure of a feature-value vector;

FIG. 5 is a diagram for describing an exemplary data structure of a feature-value vector;

FIG. 6 is a diagram for describing an exemplary data structure of a feature-value vector;

FIG. 7 is a flowchart of an exemplary process according to the first exemplary embodiment;

FIG. 8 is a flowchart of an exemplary process according to the first exemplary embodiment;

FIG. 9 is a conceptual diagram illustrating an exemplary module configuration of a second exemplary embodiment;

FIG. 10 is a conceptual diagram illustrating an exemplary module configuration of a third exemplary embodiment; and

FIG. 11 is a block diagram illustrating an exemplary hardware configuration of a computer for achieving the exemplary embodiments.

### DETAILED DESCRIPTION

Before the present exemplary embodiments are described, a technique, on the basis of which the exemplary embodiments are achieved, will be described. The description will be made in order to facilitate understanding of the exemplary embodiments.

This technique belongs to a technical field in which a degree of certainty is calculated for a character recognition result or in which correct-incorrect determination is performed on a character recognition result. In particular, the technique is one which uses character similarity and part of speech.

Character recognition is a process of converting a character pattern which is input as an image or strokes into a text code.

A degree of certainty indicates how probable it is that a text code which is a character recognition result is correct.

Some character recognition systems are operated in such a manner that a user checks and then modifies a character recognition result because an incorrect result has been output from a character recognition process. In this operation, it is expected that the efficiency of the task of checking and modifying a result will be increased by assigning a degree of certainty to an output result. For example, the foreground or the background of a character is displayed in such a manner as to be emphasized in accordance with whether the degree of certainty is high or low, thereby achieving an effect of the above-described increase in efficiency. In addition, a segment having a low degree of certainty is deleted or replaced with different text, whereby it is expected that a user will be provided with a better character recognition result.

In calculation of a degree of certainty for a character recognition result or in correct-incorrect determination of a character recognition result, the following feature values are typically used.

### (1) Feature Values of a Single Character

Character similarity

Character n-gram

Character classification

Character accuracy rate table

### (2) Feature Values of a Word

Word n-gram

Word length

Unknown word

Part of speech

Many techniques of the related art use feature values in “(1) Feature values of a single character” and “(2) Feature values of a word”, or combinations of these to achieve calculation of a degree of certainty or correct-incorrect determination. Each of the feature values will be briefly described below.

The feature values in “(1) Feature values of a single character” will be described. Character similarity indicates a similarity between a character pattern to be recognized and a representative character pattern for a text code in a character recognition result (for example, a character pattern in a recognition dictionary; however, this depends on what character recognition method is used), or indicates a degree of certainty in identification of a single character (character recognition in which a character pattern to be recognized is regarded as a single character). Character n-gram indicates occurrence probabilities of text codes, the number of which is n and which appear successively. Character classification indicates a large classification system for text codes in which a text code is classified into, for example, a Kanji character, a Hiragana character, a Katakana character, an alphabetical character, or a numerical character. Character accuracy rate table indicates a table in which accuracy rates for text codes which are output from a target character recognition system are summarized in advance. A case where a specific text code is determined to be incorrect (i.e., is blacklisted) is also classified as a feature value of this kind.

The feature values in “(2) Feature values of a word” will be described. Word n-gram indicates occurrence probabilities of words, the number of which is n and which appear successively. Word length indicates the number of characters in a word. Unknown word indicates a word which has not been registered in a word dictionary. Part of speech indicates a classification which is attached to a word in a morphological analysis result and which is based on the grammatical function of the word, such as noun or verb. Morphological analysis is a process in which a text code sequence is segmented into words on a grammatical basis. An example of a known technique is one described in “Applying Conditional Random Fields to Japanese Morphological Analysis” (In Proc. of EMNLP, pp. 230-237, 2004) written by Taku Kudo, Kaoru Yamamoto, and Yuji Matsumoto (hereinafter, referred to as Non-Patent Document 1).

The exemplary embodiment particularly belongs to a technique of calculating a degree of certainty for a character recognition result by using character similarity and part of speech.

For example, a method described in Japanese Unexamined Patent Application Publication No. 63-24381 uses character similarity and unknown word. Specifically, a segment having a low character similarity or a segment which is determined to be an unknown word is regarded as having a low degree of certainty.

In “A Method for Detecting Errors in Japanese Sentences Based on Morphological Analysis Using Minimal Cost Path Search” (Trans. IPS Japan, Vol. 33, No. 4, April, 1992) written by Hideki Shimomura, Mitaro Namiki, Masaki Nakagawa, and Nobumasa Tahahashi (hereinafter, referred to as Non-Patent Document 2), a method using part-of-speech cost is described. Specifically, a segment in which the costs (i.e., the degree of incorrectness in terms of grammar) of individual parts of speech referred to in morphological analysis are high is regarded as having a low degree of certainty.

In “An Error Detection Method Using N-gram Statistical Data on Parts of Speech in Japanese Text” (IPSJ SIG Notes (Onsei Gengo Jyoho Shori), 19-15, pp. 95-100, 12 Dec., 1997) written by Masahiro Ishiba, Tetsuo Takeyama, Tsuneo Aoki, Yasuaki Hyodo, and Takashi Ikeda (hereinafter, referred to as Non-Patent Document 3), a method using part-of-speech 4-gram is described. Specifically, on the basis of part-of-speech 4-gram information which is summarized from a correct document database, a sequence of parts of speech in a character recognition result is evaluated. A segment having a low value which is obtained by the evaluation is regarded as having a low degree of certainty. In addition, a segment of a one-character noun (i.e., this corresponds to use of word length and part of speech) or an unknown word is regarded as having a low degree of certainty.

A method described in Japanese Unexamined Patent Application Publication No. 05-89281 uses unknown word and part of speech. Specifically, a segment which is probably a proper noun although being an unknown word is regarded as having a low degree of certainty. In addition, complicated rules for correct-incorrect determination are defined by combining pieces of information about, for example, a single-Kanji-character uninflected word, similarity to the character shape of a character difficult to incorrectly read, a single Katakana character, and successive punctuation marks or incorrectly used brackets.

A method described in Japanese Unexamined Patent Application Publication No. 09-134410 uses word length, part of speech, word {1,2}-gram, and character similarity. Specifically, a degree of certainty is calculated from feature values of a word. When the degree of certainty is equal to or less than a predetermined threshold, the degree of certainty is further modified by using character similarity.

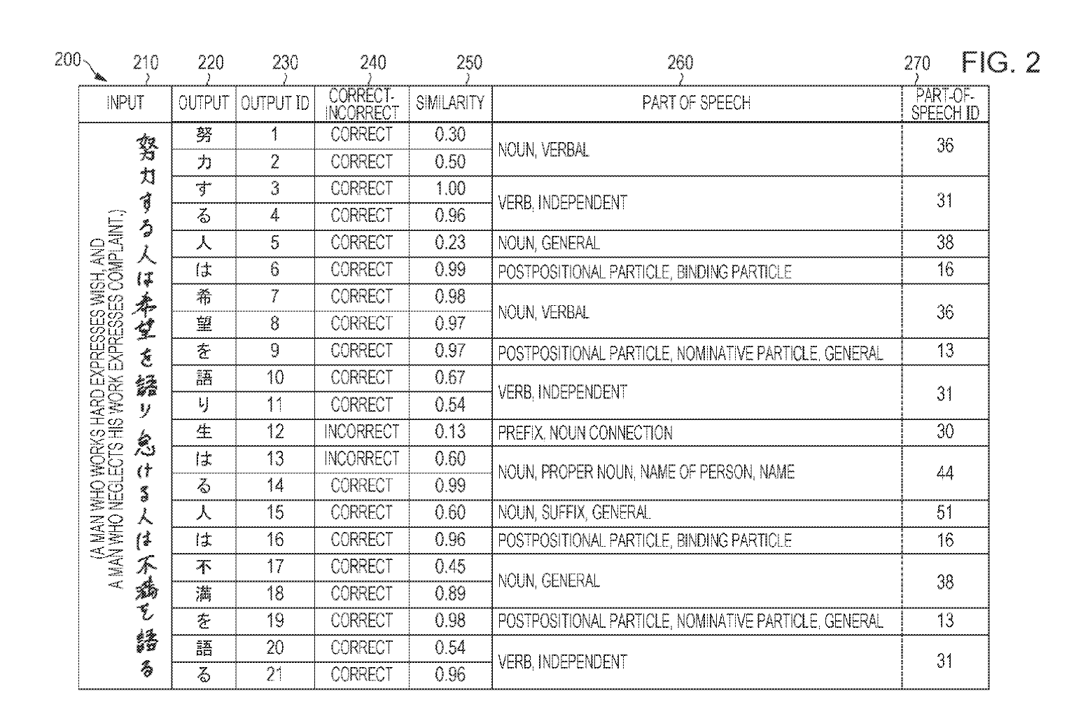

The methods described in the documents of the related art do not use character similarity and part of speech at the same time. Therefore, a correct degree of certainty is prevented from being calculated. This will be described below taking FIG. 2 as an example.

Assume that recognition results for an “input” pattern (input column 210) are obtained as illustrated in “output” data (output column 220). Whether a recognition result is correct or incorrect is illustrated in “correct-incorrect” data (correct-incorrect column 240) in which a Japanese character ‘ [symbol] ’ (output ID 12) and a Japanese character ‘ [symbol] ’ (output ID=13) are incorrect, whereas the other characters are correct. When it is judged that, the higher the degree of certainty for a character is, the higher the probability of the character being correct is, it is desirable to output a minimum value as a calculation result in incorrect recognition and to output a maximum value as a calculation result in correct recognition. An output ID (output ID column 230) is an index of the text string of the recognition results. A part-of-speech ID (part-of-speech ID column 270) is an index of the parts of speech registered in a morphological analysis system.

It is difficult to calculate a correct degree of certainty only from character similarity (similarity column 250). For example, in FIG. 2, a Japanese character ‘ [symbol] ’ (output ID=3) which is a correct character has a character similarity of 1.00, whereas the Japanese character ‘ [symbol] ’ (output ID=12) which is an incorrect character has a character similarity of 0.13. In contrast, a Japanese character ‘ [symbol] ’ (output ID=1) which is a correct character has a character similarity of 0.30, whereas the Japanese character ‘ [symbol] ’ (output ID=13) which is an incorrect character has a character similarity of 0.60. Thus, in some combinations of an input pattern and a character recognition system, character similarity and degree of certainty do not correlate with each other. Accordingly, in a method as described in Japanese Unexamined Patent Application Publication No. 63-24381 in which a segment having a lower character similarity is regarded as having a lower degree of certainty, a correct degree of certainty is not always calculated.

Similarly, it is difficult to calculate a degree of certainty only from part of speech (part-of-speech column 260). For example, no correct grammar rules may be used in a document in colloquial style, and the sequence of parts of speech may be incorrect. In contrast, regardless of an error which occurs in character recognition, the grammar rule may be adhered, and a sequence of parts of speech may be correct. Therefore, a method based on deviation from the grammar rule, as described in Non-Patent Document 2 or Non-Patent Document 3, does not always calculate a correct degree of certainty. In addition, a specific part of speech does not always have a low degree of certainty. Therefore, a method based on a specific part of speech, as described in Japanese Unexamined Patent Application Publication No. 05-89281, does not always calculate a correct degree of certainty.

A character recognition system and a morphological analysis system have respective specific tendencies. In addition, behaviors of the systems depend on a target input pattern (an image or strokes, or a linguistic pattern in a document) to a large extent. Therefore, to achieve highly accurate calculation of a degree of certainty, designs which are optimized for individual combinations are required. A method described in Japanese Unexamined Patent Application Publication No. 05-89281 establishes complicated rules from a large number of features. Accordingly, the above-described optimization requires a large amount of efforts.

As described above, a method based on only character similarity or only part of speech does not always calculate a correct degree of certainty. Therefore, the method described in Japanese Unexamined Patent Application Publication No. 09-134410 uses character similarity and part of speech.

However, a degree of certainty is first calculated only from feature values of a word. Therefore, a high degree of certainty may be erroneously calculated in this stage. That is, the method in Japanese Unexamined Patent Application Publication No. 09-134410 does not calculate a degree of certainty by using character similarity and part of speech at the same time, thereby having a disadvantage in that a correct degree of certainty is not always calculated. In addition, to calculate a degree of certainty, a language-processing degree-of-certainty table for calculating a degree of certainty by using a combination of elements of part of speech, word length, and word {1,2}-gram as a search key is generated in advance. When a large number of elements are used to achieve high accuracy, the number of combinations for the search key is large, causing the size of the table to be large.

Various exemplary embodiments which achieve the present invention will be described below on the basis of the drawings.

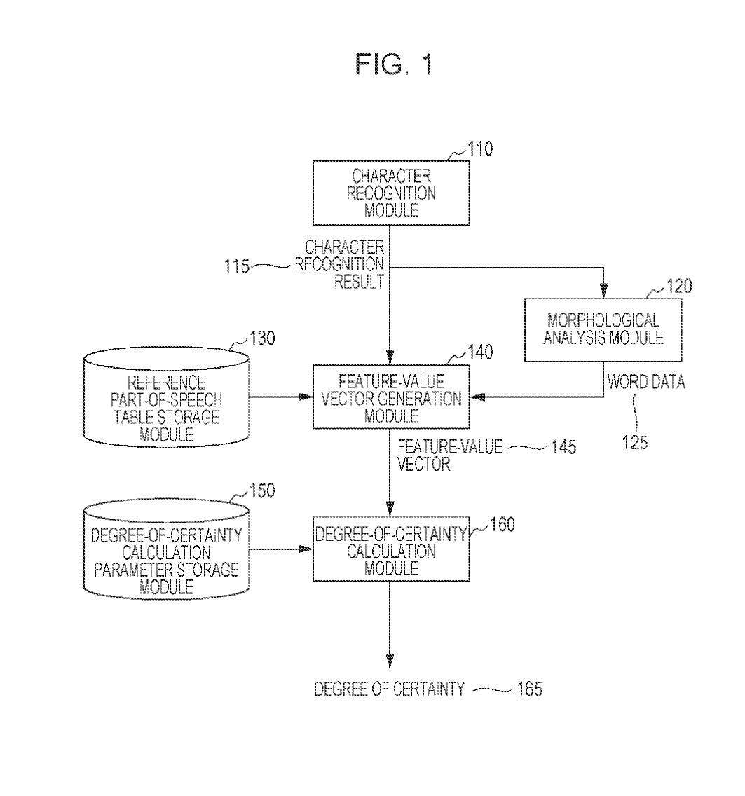

FIG. 1 is a conceptual diagram illustrating an exemplary module configuration of a first exemplary embodiment.

In general, a module refers to a component, such as software that is logically separable (a computer program) or hardware. Thus, a module in the exemplary embodiment refers to not only a module in terms of a computer program but also a module in terms of a hardware configuration. Consequently, the description for the exemplary embodiment serves as the description of a system, a method, and a computer program which cause the hardware configuration to function as a module (a program that causes a computer to execute procedures, a program that causes a computer to function as units, or a program that causes a computer to implement functions). For convenience of explanation, the terms “to store something” and “to cause something to store something”, and equivalent terms are used. These terms mean that a storage apparatus stores something or that a storage apparatus is controlled so as to store something, when computer programs are used in the exemplary embodiment. One module may correspond to one function. However, in the implementation, one module may constitute one program, or multiple modules may constitute one program. Alternatively, multiple programs may constitute one module. Additionally, multiple modules may be executed by one computer, or one module may be executed by multiple computers in a distributed or parallel processing environment. One module may include another module. Hereinafter, the term “connect” refers to logical connection, such as transmission/reception of data, an instruction, or reference relationship between pieces of data, as well as physical connection. The term “predetermined” refers to a state in which determination has been made before a target process. This term also includes a meaning in which determination has been made in accordance with the situation or the state at that time or before that time, not only before processes according to the exemplary embodiment start, but also before the target process starts even after the processes according to the exemplary embodiment have started. When multiple “predetermined values” are present, these may be different from each other, or two or more of the values (including all values, of course) may be the same. A description having a meaning of “when A is satisfied, B is performed” is used as a meaning in which whether or not A is satisfied is determined and, when it is determined that A is satisfied, B is performed. However, this term does not include a case where the determination of whether or not A is satisfied is unnecessary.

A system or an apparatus refers to one in which multiple computers, pieces of hardware, devices, and the like are connected to each other by using a communication unit such as a network which includes one-to-one communication connection, and also refers to one which is implemented by using a computer, a piece of hardware, a device, or the like. The terms “apparatus” and “system” are used as terms that are equivalent to each other. As a matter of course, the term “system” does not include what is nothing more than a social “mechanism” (social system) which is constituted by man-made agreements.

In each of the processes corresponding to modules, or in each of the processes included in a module, target information is read out from a storage apparatus. After the process is performed, the processing result is written in a storage apparatus. Accordingly, no description about the readout from the storage apparatus before the process and the writing into the storage apparatus after the process may be made. Examples of the storage apparatus may include a hard disk, a random access memory (RAM), an external storage medium, a storage apparatus via a communication line, and a register in a central processing unit (CPU).

An information processing apparatus according to the first exemplary embodiment calculates a degree of certainty for each of the characters in a character recognition result, and includes a character recognition module 110, a morphological analysis module 120, a reference part-of-speech table storage module 130, a feature-value vector generation module 140, a degree-of-certainty calculation parameter storage module 150, and a degree-of-certainty calculation module 160 as illustrated in the example in FIG. 1. Specifically, the information processing apparatus uses character similarity and part of speech at the same time to calculate a degree of certainty. The term “to use something at the same time” means that character similarity and part of speech are equally handled, and does not include the case where they are separately evaluated, e.g., evaluated in two stages.

The character recognition module 110 is connected to the morphological analysis module 120 and the feature-value vector generation module 140. The character recognition module 110 performs character recognition on a character pattern which has been input. The character recognition module 110 may use a known character recognition technique. The character recognition module 110 calculates a character similarity for each of the characters to be recognized. The character recognition module 110 then outputs a text string and character similarities for the characters as a character recognition result 115. For example, the data structure of the character recognition result 115 is a table constituted by the output column 220, the output ID column 230, and the similarity column 250 in a correct-incorrect/character-similarity/part-of-speech table 200 for a character recognition result illustrated in the example in FIG. 2. The character recognition in this stage may be offline character recognition to perform recognition on an image, or may be online character recognition to perform recognition on strokes.

The morphological analysis module 120 is connected to the character recognition module 110 and the feature-value vector generation module 140. The morphological analysis module 120 performs morphological analysis on the text string in the character recognition result 115 which is output from the character recognition module 110. For example, a result of the morphological analysis (i.e., word data 125) is a table constituted by the output column 220, the output ID column 230, the part-of-speech column 260, and the part-of-speech ID column 270 in the correct-incorrect/character-similarity/part-of-speech table 200 for a character recognition result illustrated in the example in FIG. 2.

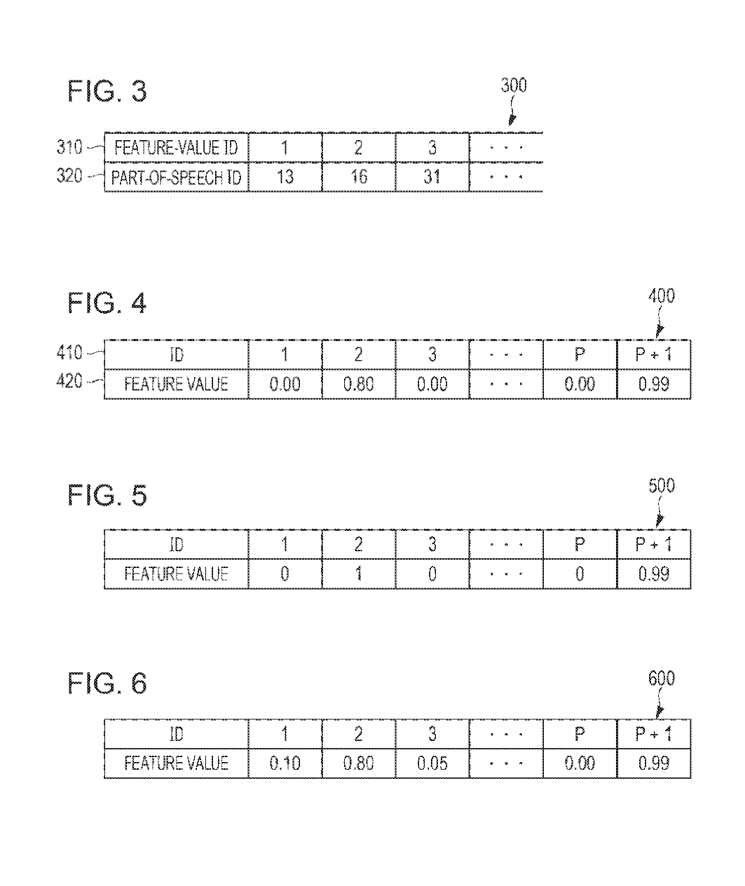

The reference part-of-speech table storage module 130 is connected to the feature-value vector generation module 140. The reference part-of-speech table storage module 130 stores a reference part-of-speech table. The reference part-of-speech table is a table indicating a correspondence between the index of a part of speech (i.e., a part-of-speech ID) and the index in a feature-value vector (hereinafter, referred to as a feature-value ID) which are referred to in order to create a feature-value vector. FIG. 3 is a diagram for describing an exemplary data structure of a reference part-of-speech table 300. The reference part-of-speech table 300 includes a feature-value ID row 310 and a part-of-speech ID row 320 which correspond to each other. The morphological analysis module 120 may output Pₘₐₓ (≧P) types of part of speech. Any one of the numbers 1 to P is set to a feature-value ID.

The feature-value vector generation module 140 is connected to the character recognition module 110, the morphological analysis module 120, the reference part-of-speech table storage module 130, and the degree-of-certainty calculation module 160. The feature-value vector generation module 140 generates a feature-value vector having a length of P+1, from one character similarity and part-of-speech likelihoods, the number of which is P. The number P is a predetermined integer (the number of parts of speech to be used in the morphological analysis module 120). That is, for each character in the character recognition result 115, the feature-value vector generation module 140 generates a feature-value vector 145 that has elements, the number of which is P+1, and that is constituted by the following: part-of-speech likelihoods which corresponds to P types of part of speech and which are generated from the probability of the part of speech of a word in the word data 125 which includes the target character and which is the result of the morphological analysis performed by the morphological analysis module 120; and a character similarity for the target character. At that time, the feature-value vector generation module 140 refers to the reference part-of-speech table 300 stored in the reference part-of-speech table storage module 130.

How to generate a feature-value vector for a target character will be described below on the basis of the reference part-of-speech table 300. First, all of the elements of the feature-value vector are initialized to zero. Then, a feature-value ID is retrieved from the reference part-of-speech table 300 by using the part-of-speech ID of the part of speech of the word including the target character as a key. A part-of-speech likelihood is written at the position indicated by the retrieved feature-value ID, in the feature-value vector. Part-of-speech likelihood indicates a cost or a probability of a part of speech which is similar to that used in Non-Patent Document 2. A character similarity is written as the (P+1)th feature value. FIG. 4 illustrates an example of a feature-value vector generated for the Japanese character ‘ha’ (character ID=6) in FIG. 2. A feature-value vector 400 includes an ID row 410 and a feature-value row 420 which correspond to each other. The feature-value vector 400 has elements, the number of which is P+1 and among which P elements describe part-of-speech likelihoods and one element describes a character similarity.

The part-of-speech likelihoods may be quantized as illustrated in the example in FIG. 5. A feature-value vector 500 has a data structure equivalent to that of the feature-value vector 400. In the feature-value vector 500, the part-of-speech likelihood of the part of speech of the word which includes a target character and which is a result of the morphological analysis performed by the morphological analysis module 120 is set to 1, and the part-of-speech likelihoods of the other parts of speech are set to 0. Specifically, the part-of-speech likelihood (feature value) for the feature-value ID which is 2 is set to 1, and the part-of-speech likelihoods (feature values) of the elements for the feature-value IDs which are 1 to P except 2 (of course, (P+1)th element is not included) are set to 0.

As the character feature value, multiple part-of-speech likelihoods each may have a value equal to or more than zero, as illustrated in the example in FIG. 6. A feature-value vector 600 has a data structure equivalent to that of the feature-value vector 400. When the word including a target character has multiple part-of-speech likelihoods for parts of speech, or when the morphological analysis performed by the morphological analysis module 120 outputs multiple results and a target character belongs to multiple words, a feature-value vector like the feature-value vector 600 is generated.

Any one of the feature-value vectors 400, 500, and 600 is used as the data structure of the feature-value vector 145 which is output by the feature-value vector generation module 140.

Character similarity may be a value which is normalized by using character similarities of candidate characters other than the character which is output by the character recognition module 110. Alternatively, both of the values before and after normalization may be used. For example, for each of the character similarities of the top N characters which have higher character similarities in the character recognition result for a single character, the feature-value vector generation module 140 may use, as the character similarity, a character similarity obtained by normalizing the character similarity in the character recognition result on which morphological analysis is to be performed by the morphological analysis module 120, by using the character similarities of the top N characters. Specifically, the normalization is performed by using Expression 3 or 4. Here, cᵢ is a character similarity of the normalization target which is to be normalized by using N character similarities including cᵢ. The symbol N represents a predetermined integer equal to or more than 2.

$$\begin{matrix}\frac{{c}_{i}}{{\sum }_{j = 1}^{N} {c}_{j}} & Expression 3 \\ \frac{exp ( {c}_{i} )}{{\sum }_{j = 1}^{N} exp ( {c}_{j} )} & Expression 4\end{matrix}$$

Other feature values described in “(1) feature values of a single character” or “(2) feature values of a word” may be added to a feature-value vector.

The degree-of-certainty calculation module 160 is connected to the feature-value vector generation module 140 and the degree-of-certainty calculation parameter storage module 150. The degree-of-certainty calculation module 160 calculates a degree of certainty 165 for each character in the character recognition result 115, from the feature-value vector 145 generated by the feature-value vector generation module 140. For example, the degree-of-certainty calculation module 160 calculates the degree of certainty 165 by using machine learning. Degree-of-certainty calculation parameters stored in the degree-of-certainty calculation parameter storage module 150 through machine learning may be used.

The degree-of-certainty calculation parameter storage module 150 is connected to the degree-of-certainty calculation module 160. The degree-of-certainty calculation parameter storage module 150 stores the degree-of-certainty calculation parameters used in machine learning performed by the degree-of-certainty calculation module 160.

Specifically, the degree-of-certainty calculation module 160 calculates a degree of certainty by using Expression 1. In Expression 1, x represents a feature-value vector having a length of P+1, and xₚ represents the p-th element. In addition, w⁽¹⁾ represents a matrix of (P+1) rows and H columns, and w⁽¹⁾ₚₕ represents an element of the p-th row and the h-th column. The symbol w⁽²⁾ represents a vector having a length of H, and w⁽²⁾ₕ represents the h-th element. The symbol b⁽¹⁾ represents a vector having a length of H, and b⁽¹⁾ₕ represents the h-th element. The symbol b⁽²⁾ represents a numeric value. In Expression 1, H, w⁽¹⁾, w⁽²⁾, b⁽¹⁾, and b⁽²⁾ are degree-of-certainty calculation parameters to be optimized. The symbol σ represents a logistic function.

In addition, for example, a degree of certainty may be calculated by using Expression 2. The symbol V represents an index set for a representative feature-value vector x_{vεV}. The symbol a represents a vector having a length of #{V}, and aᵥ represents the v-th element. The symbol t represents a vector having a length of #{V}, and tᵥ represents the v-th element and indicates whether xᵥ is correct or incorrect. For example, when tᵥ indicates that xᵥ is correct, tᵥ is equal to 1. When tᵥ indicates that xᵥ is incorrect, tᵥ is equal to −1. The symbol K represents a function of calculating a distance between vectors. In Expression 2, V and a are degree-of-certainty calculation parameters to be optimized.

$$\begin{matrix}{\sum }_{h = 1}^{H} {w}_{h}^{( 2 )} σ ( {\sum }_{p = 1}^{P + 1} ( {w}_{p h}^{( 1 )} {x}_{p} + {b}_{h}^{( 1 )} ) ) + {b}^{( 2 )} & Expression 1 \\ {\sum }_{v ∈ V} {a}_{v} {t}_{v} K ( {x}_{v} , x ) & Expression 2\end{matrix}$$

As described above, by generating a feature-value vector, character similarity and part of speech are used at the same time in the calculation of a degree of certainty. The degree-of-certainty calculation parameter design incorporated with tendencies of an input pattern, the character recognition module 110, and the morphological analysis module 120 is optimized through a method using machine learning. In addition, the state is prevented in which the number of optimization parameters is increased as in the method described in Japanese Unexamined Patent Application Publication No. 09-134410.

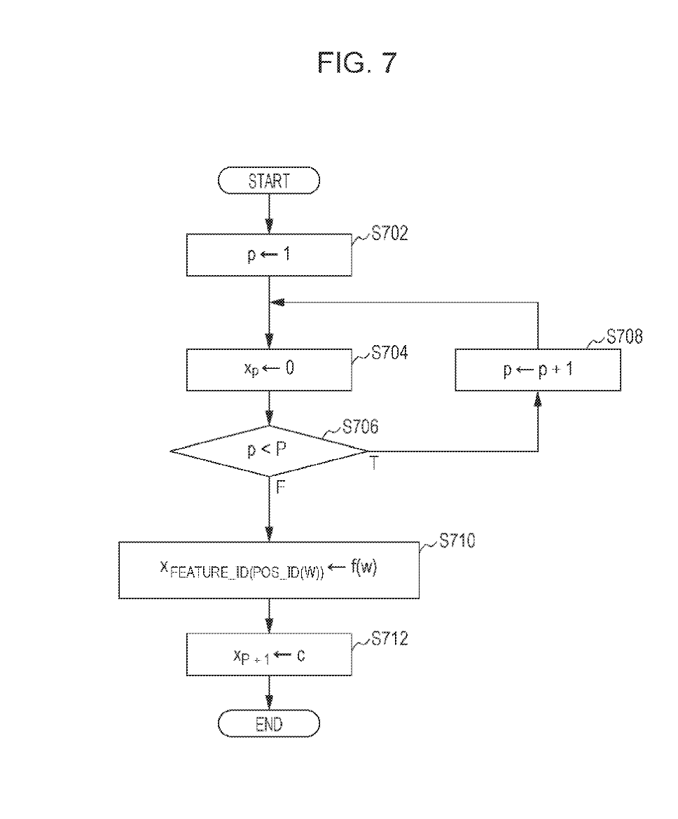

FIG. 7 is a flowchart of an exemplary process according to the first exemplary embodiment (feature-value vector generation module 140). The process according to the flowchart causes a feature-value vector 400 as illustrated in the example in FIG. 4 to be generated for a target character.

A vector x is a feature-value vector having a length of P+1 (the number of elements), and xₚ represents the p-th element.

The symbol c represents a character similarity for a target character.

The symbol w represents a morphological analysis result which is a word including the target character.

The symbol POS_ID is a function which returns the part-of-speech ID of the part of speech of w.

The symbol FEATURE_ID is a function which returns the feature-value ID corresponding to a part-of-speech ID on the basis of the reference part-of-speech table 300.

The symbol f is a function which returns a part-of-speech likelihood for the part of speech of w.

As described above, f may be a function which returns 1. At that time, a feature-value vector 500 as illustrated in the example in FIG. 5 is generated.

In step S702, 1 is assigned to p.

In step S704, 0 is assigned to xₚ.

In step S706, it is determined whether or not p<P. If p<P, the process proceeds to step S708. Otherwise, the process proceeds to step S710.

In step S708, p is incremented by 1. Then, the process returns back to step S704.

In step S710, a value obtained from f(w) is assigned to x_{FEATURE}_{_{—}}_{ID(POS}_{_{—}}_{ID(w))} according to Expression 5.

x_{FEATURE}_{_{—}}_{ID(POS}_{_{—}}_{ID(w))}←f(w) Expression 5

In step S712, c is assigned to x_{P+1}.

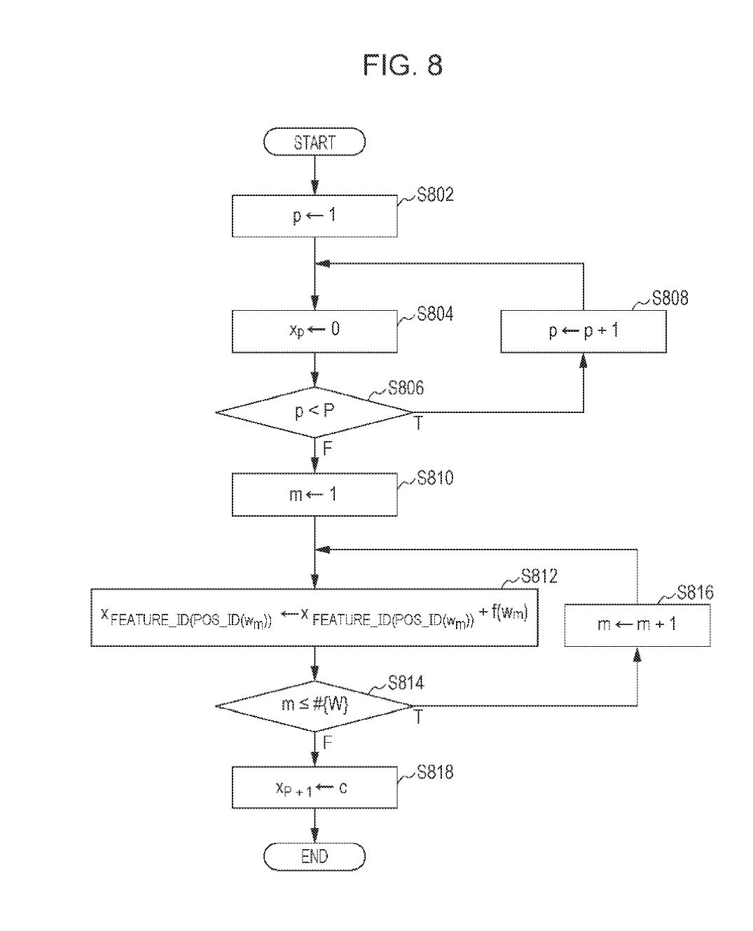

FIG. 8 is a flowchart of an exemplary process according to the first exemplary embodiment (feature-value vector generation module 140). This is a process of generating a feature-value vector having multiple part-of-speech likelihoods that are equal to or more than zero. The process according to the flowchart causes a feature-value vector 600 as in the example in FIG. 6 to be generated for a target character.

The symbol W represents a set of words, to which a target character belongs, and has elements, the number of which is #{W}. For the sake of simplicity, when one word has multiple part-of-speech likelihoods, each of the part-of-speech likelihoods is regarded as belonging to a different word. The symbol wₘ represents an element of W.

In step S802, 1 is assigned to p.

In step S804, 0 is assigned to xₚ.

In step S806, it is determined whether or not p<P. If p<P, the process proceeds to step S808. Otherwise, the process proceeds to step S810.

In step S808, p is incremented by 1. Then, the process returns back to step S804.

In step S810, 1 is assigned to m.

In step S812, a value obtained from x_{FEATURE}_{_{—}}_{ID(POS}_{_{—}}_{ID(wm))}+f(wₘ) is assigned to x_{FEATURE}_{_{—}}_{ID(POS}_{_{—}}_{ID(wm))} according to Expression 6.

x_{FEATURE}_{_{—}}_{ID(POS}_{_{—}}_{ID(wm))}←x_{FEATURE}_{_{—}}_{ID(POS}_{_{—}}_{ID(wm))}+f(wₘ) Expression 6

In step S814, it is determined whether or not m≦#{W}. If m≦#{W}, the process proceeds to step S816. Otherwise, the process proceeds to step S818.

In step S816, m is incremented by 1. Then the process returns back to step S812.

In step S818, c is assigned to x_{P+1}.

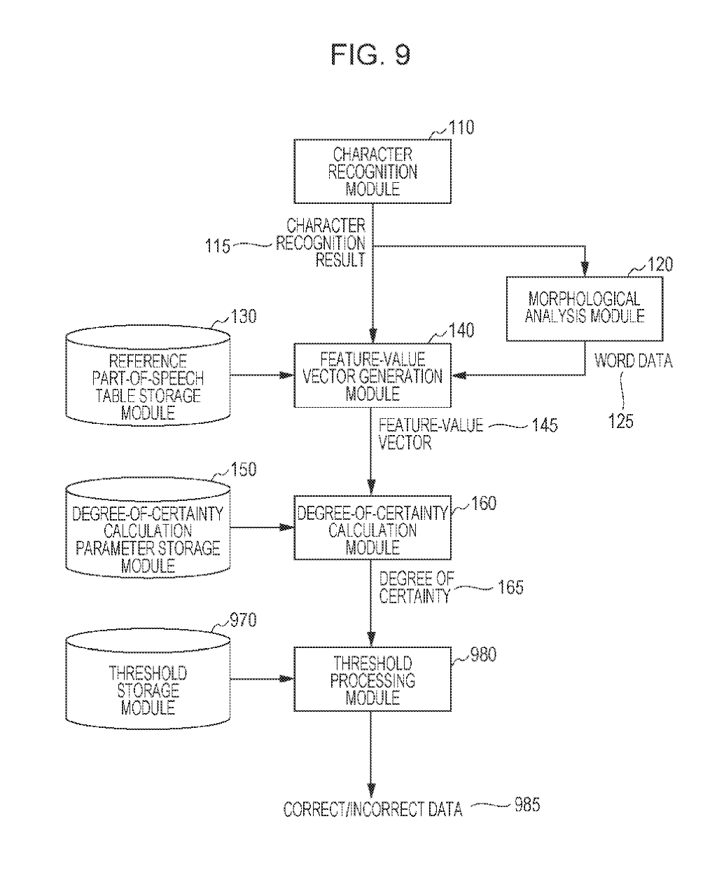

FIG. 9 is a conceptual diagram illustrating an exemplary module configuration of a second exemplary embodiment. The same type of component as that in the first exemplary embodiment is designated with the same reference numeral, and will not be described (the same is true for other exemplary embodiments). In the second exemplary embodiment, correct-incorrect determination is performed. As illustrated in the example in FIG. 9, an information processing apparatus includes the character recognition module 110, the morphological analysis module 120, the reference part-of-speech table storage module 130, the feature-value vector generation module 140, the degree-of-certainty calculation parameter storage module 150, the degree-of-certainty calculation module 160, a threshold storage module 970, and a threshold processing module 980.

The character recognition module 110 is connected to the morphological analysis module 120 and the feature-value vector generation module 140.

The morphological analysis module 120 is connected to the character recognition module 110 and the feature-value vector generation module 140.

The reference part-of-speech table storage module 130 is connected to the feature-value vector generation module 140.

The feature-value vector generation module 140 is connected to the character recognition module 110, the morphological analysis module 120, the reference part-of-speech table storage module 130, and the degree-of-certainty calculation module 160.

The degree-of-certainty calculation parameter storage module 150 is connected to the degree-of-certainty calculation module 160.

The degree-of-certainty calculation module 160 is connected to the feature-value vector generation module 140, the degree-of-certainty calculation parameter storage module 150, and the threshold processing module 980.

The threshold storage module 970 is connected to the threshold processing module 980. The threshold storage module 970 stores a threshold used by the threshold processing module 980.

The threshold processing module 980 is connected to the degree-of-certainty calculation module 160 and the threshold storage module 970. The threshold processing module 980 determines correct/incorrect data 985 for a character recognition result by comparing the degree of certainty 165 with the predetermined threshold stored in the threshold storage module 970. At that time, when the degree of certainty has a higher value, the degree of certainty is regarded as a correct result. Accordingly, a degree of certainty having a value larger than (or equal to or larger than) the threshold is output as a correct result, and a degree of certainty which is equal to or smaller than (or smaller than) the threshold is output as an incorrect result.

After the process performed by the threshold processing module 980, the following processes as described below may be performed.

(A) Characters (character recognition result) which are determined to be incorrect by the threshold processing module 980 may be deleted from the character recognition result which is to be output as a result according to the second exemplary embodiment.
(B) Characters which are determined to be incorrect by the threshold processing module 980 may be replaced with other characters. The other characters are those indicating that the result of character recognition is incorrect, and, for example, are black square characters.
(C) The information processing apparatus may also include a search module which searches the character recognition result 115. Searching may be performed using a search key in which a wild card is set to the position at which a character which is determined to be incorrect by the threshold processing module 980 is present. That is, searching is performed with a character which is determined to be incorrect being regarded as any character string (string having a length equal to or more than zero).

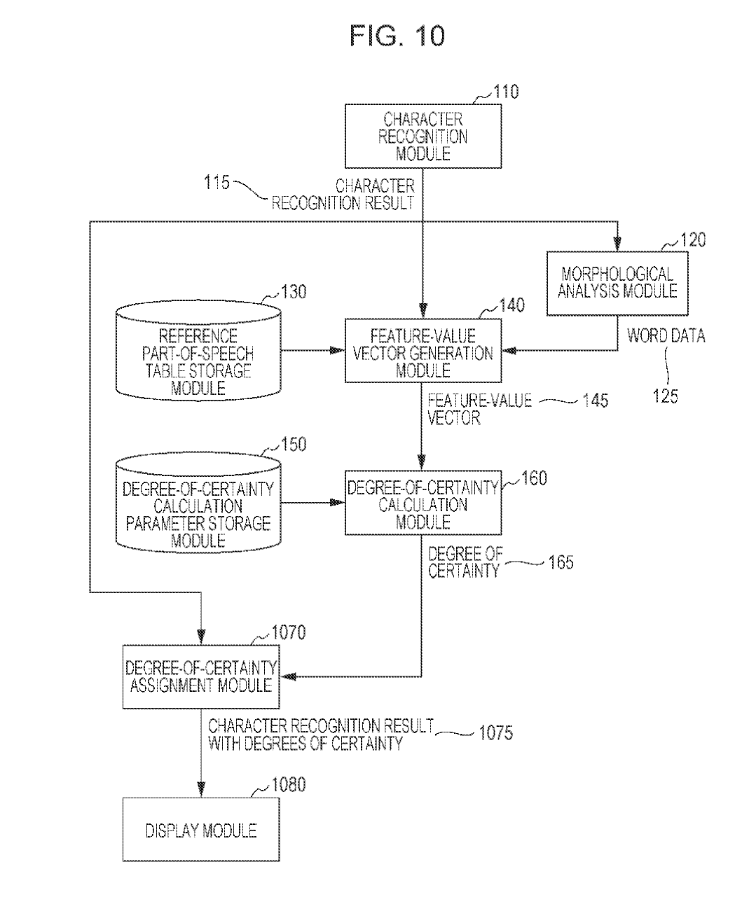

FIG. 10 is a conceptual diagram illustrating an exemplary module configuration of a third exemplary embodiment.

In the third exemplary embodiment, the display of a result is switched in accordance with a degree of certainty. As illustrated in FIG. 10, an information processing apparatus includes the character recognition module 110, the morphological analysis module 120, the reference part-of-speech table storage module 130, the feature-value vector generation module 140, the degree-of-certainty calculation parameter storage module 150, the degree-of-certainty calculation module 160, a degree-of-certainty assignment module 1070, and a display module 1080.

The character recognition module 110 is connected to the morphological analysis module 120, the feature-value vector generation module 140, and the degree-of-certainty assignment module 1070.

The morphological analysis module 120 is connected to the character recognition module 110 and the feature-value vector generation module 140.

The reference part-of-speech table storage module 130 is connected to the feature-value vector generation module 140.

The feature-value vector generation module 140 is connected to the character recognition module 110, the morphological analysis module 120, the reference part-of-speech table storage module 130, and the degree-of-certainty calculation module 160.

The degree-of-certainty calculation parameter storage module 150 is connected to the degree-of-certainty calculation module 160.

The degree-of-certainty calculation module 160 is connected to the feature-value vector generation module 140, the degree-of-certainty calculation parameter storage module 150, and the degree-of-certainty assignment module 1070.

The degree-of-certainty assignment module 1070 is connected to the character recognition module 110, the degree-of-certainty calculation module 160, and the display module 1080. The degree-of-certainty assignment module 1070 assigns a degree of certainty 165 to each recognized character in the character recognition result 115.

The display module 1080 is connected to the degree-of-certainty assignment module 1070. The display module 1080 displays a character recognition result 1075 with degrees of certainty assigned by the degree-of-certainty assignment module 1070 on a display apparatus such as a liquid crystal display in such a manner that the character recognition result 1075 is emphasized in accordance with whether a degree of certainty is high or low. For example, y represents the degree of certainty for a target character according to the exemplary embodiment. The character color and the background color of the target character are set to (0, 0, 0) and (255, 255*(1−g(y)), 255*(1−g(y))), respectively, in the RGB display system. The output range of the function g is [0, 1].

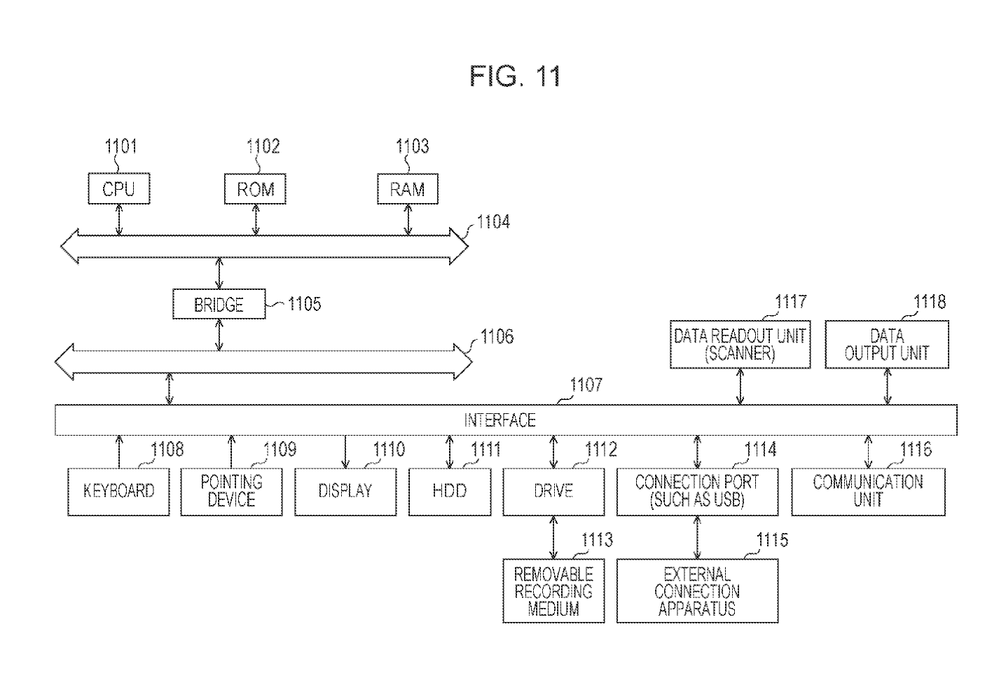

With reference to FIG. 11, an exemplary hardware configuration of the information processing apparatus according to the exemplary embodiments will be described. The configuration illustrated in FIG. 11 is constituted by, for example, a personal computer (PC), and includes a data readout unit 1117 such as a scanner and a data output unit 1118 such as a printer.

A CPU 1101 is a controller which performs processes in accordance with computer programs describing execution sequences in various modules described in the above-described exemplary embodiments, i.e., the character recognition module 110, the morphological analysis module 120, the feature-value vector generation module 140, the degree-of-certainty calculation module 160, the threshold processing module 980, the degree-of-certainty assignment module 1070, and the display module 1080.

A read only memory (ROM) 1102 stores, for example, programs and computation parameters which are used by the CPU 1101. A RAM 1103 stores, for example, programs used in the execution performed by the CPU 1101, and parameters which are changed as appropriate in the execution. These are connected to each other via a host bus 1104 constituted by, for example, a CPU bus.

The host bus 1104 is connected to an external bus 1106 such as a peripheral component interconnect/interface (PCI) bus via a bridge 1105.

A keyboard 1108 and a pointing device 1109 such as a mouse are input devices with which an operator operates. A display 1110 is, for example, a liquid-crystal display apparatus or a cathode ray tube (CRT), and displays various types of information as text or image information.

A hard disk drive (HDD) 1111 includes a hard disk therein, and drives the hard disk to record or reproduce programs executed by the CPU 1101 and information. In the hard disk, for example, the character recognition result 115, the word data 125, the feature-value vector 145, the degree of certainty 165, the correct-incorrect/character-similarity/part-of-speech table 200 for a character recognition result, the reference part-of-speech table 300, the feature-value vector 400, the correct/incorrect data 985, and the character recognition result 1075 with degrees of certainty are stored. In addition, various computer programs such as various other data processing programs are stored.

A drive 1112 reads out data or programs which are stored in a removable recording medium 1113 mounted therein, such as a magnetic disk, an optical disk, a magneto-optical disk, or a semiconductor memory, and supplies the data or the programs to the RAM 1103 connected via an interface 1107, the external bus 1106, the bridge 1105, and the host bus 1104. The removable recording medium 1113 may be also used as a data recording area similar to the hard disk.

A connection port 1114 is a port for connecting an external connection apparatus 1115, and has a connecting portion that supports, for example, Universal Serial Bus (USB) or IEEE1394. The connection port 1114 is connected to, for example, the CPU 1101 via the interface 1107, the external bus 1106, the bridge 1105, the host bus 1104, and the like. A communication unit 1116 is connected to a communication line, and performs data communication with the outside. The data readout unit 1117 is, for example, a scanner, and reads out a document. The data output unit 1118 is, for example, a printer, and outputs document data.

The hardware configuration of an information processing apparatus illustrated in FIG. 11 is one exemplary configuration. The hardware configuration according to the exemplary embodiments is not limited to that illustrated in FIG. 11, and may be any configuration as long as the configuration enables the modules described in the exemplary embodiments to be executed. For example, some of the modules may be achieved by using dedicated hardware, such as an application specific integrated circuit (ASIC); some of the modules may be present in an external system which is connected via a communication line; or multiple systems illustrated in FIG. 11 may be connected with each other via a communication line so as to cooperate with each other. Further, the modules may be incorporated in, for example, a copier, a facsimile, a scanner, a printer, a multi-function device (image processing apparatus having any two or more functions of a scanner, a printer, a copier, a facsimile, and the like).

The programs described above may be provided through a recording medium which stores the programs, or may be provided through a communication unit. In these cases, for example, the programs described above may be interpreted as an invention of “a computer-readable recording medium that stores programs”.

The term “a computer-readable recording medium that stores programs” refers to a computer-readable recording medium that stores programs and that is used for, for example, the installation and execution of the programs and the distribution of the programs.

Examples of the recording medium include a digital versatile disk (DVD) having a format of “DVD-recordable (DVD-R), DVD-rewritable (DVD-RW), DVD-random access memory (DVD-RAM), or the like” which is a standard developed by the DVD forum or having a format of “DVD+recordable (DVD+R), DVD+rewritable (DVD+RW), or the like” which is a standard developed by the DVD+RW alliance, a compact disk (CD) having a format of CD read only memory (CD-ROM), CD recordable (CD-R), CD rewritable (CD-RW), or the like, a Blu-ray Disc®, a magneto-optical disk (MO), a flexible disk (FD), a magnetic tape, a hard disk, a ROM, an electrically erasable programmable ROM (EEPROM®), a flash memory, a RAM, and a secure digital (SD) memory card.

The above-described programs or some of them may be stored and distributed by recording them on the recording medium. In addition, the programs may be transmitted through communication, for example, by using a transmission media of, for example, a wired network which is used for a local area network (LAN), a metropolitan area network (MAN), a wide area network (WAN), the Internet, an intranet, an extranet, and the like, a wireless communication network, or a combination of these. Instead, the programs may be carried on carrier waves.

The above-described programs may be included in other programs, or may be recorded on a recording medium along with other programs. Instead, the programs may be recorded on multiple recording media by dividing the programs. The programs may be recorded in any format, such as compression or encryption, as long as it is possible to restore the programs.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a morphological analysis unit that performs morphological analysis on a character recognition result;
a feature-value vector generation unit that generates a feature-value vector having elements, the number of which is P+1, for each character in the character recognition result, the feature-value vector including part-of-speech likelihoods and a character similarity for the character in the character recognition result, the part-of-speech likelihoods corresponding to P types of part of speech and being generated on the basis of a probability of a part of speech of a word which includes the character and which is the result of the morphological analysis performed by the morphological analysis unit; and
a degree-of-certainty calculation unit that calculates a degree of certainty for each character in the character recognition result from the feature-value vector generated by the feature-value vector generation unit.

2. The information processing apparatus according to claim 1,
wherein the part-of-speech likelihoods are set in such a manner that a part-of-speech likelihood of the part of speech of the word which includes the character and which is the result of the morphological analysis performed by the morphological analysis unit is set to 1, and the other part-of-speech likelihoods are set to 0.

3. The information processing apparatus according to claim 1,
wherein, for each of character similarities of top N characters which have higher character similarities in the character recognition result for a single character, the feature-value vector generation unit uses, as the character similarity, a character similarity obtained by normalizing a character similarity in the character recognition result on which morphological analysis is to be performed by the morphological analysis unit, by using the character similarities of the top N characters.

4. The information processing apparatus according to claim 2,
wherein, for each of character similarities of top N characters which have higher character similarities in the character recognition result for a single character, the feature-value vector generation unit uses, as the character similarity, a character similarity obtained by normalizing a character similarity in the character recognition result on which morphological analysis is to be performed by the morphological analysis unit, by using the character similarities of the top N characters.

5. The information processing apparatus according to claim 1, further comprising:
a determination unit that determines whether the character recognition result is correct or incorrect by comparing the degree of certainty with a predetermined threshold.

6. The information processing apparatus according to claim 2, further comprising:
a determination unit that determines whether the character recognition result is correct or incorrect by comparing the degree of certainty with a predetermined threshold.

7. The information processing apparatus according to claim 3, further comprising:
a determination unit that determines whether the character recognition result is correct or incorrect by comparing the degree of certainty with a predetermined threshold.

8. The information processing apparatus according to claim 4, further comprising:
a determination unit that determines whether the character recognition result is correct or incorrect by comparing the degree of certainty with a predetermined threshold.

9. The information processing apparatus according to claim 1, further comprising:
an assignment unit that assigns the degree of certainty to the character recognition result; and
a display that displays the character recognition result to which the degree of certainty is assigned by the assignment unit, in such a manner that the character recognition result is emphasized in accordance with whether the degree of certainty is high or low.

10. The information processing apparatus according to claim 2, further comprising:
an assignment unit that assigns the degree of certainty to the character recognition result; and
a display that displays the character recognition result to which the degree of certainty is assigned by the assignment unit, in such a manner that the character recognition result is emphasized in accordance with whether the degree of certainty is high or low.

11. The information processing apparatus according to claim 3, further comprising:
an assignment unit that assigns the degree of certainty to the character recognition result; and
a display that displays the character recognition result to which the degree of certainty is assigned by the assignment unit, in such a manner that the character recognition result is emphasized in accordance with whether the degree of certainty is high or low.

12. The information processing apparatus according to claim 4, further comprising:
an assignment unit that assigns the degree of certainty to the character recognition result; and
a display that displays the character recognition result to which the degree of certainty is assigned by the assignment unit, in such a manner that the character recognition result is emphasized in accordance with whether the degree of certainty is high or low.

13. The information processing apparatus according to claim 5, further comprising:
a deletion unit that deletes a character determined to be incorrect by the determination unit from the character recognition result.

14. The information processing apparatus according to claim 5, further comprising:
a replacement unit that replaces a character determined to be incorrect by the determination unit with another character.

15. The information processing apparatus according to claim 5, further comprising:
a search unit that performs searching using a search key in which a character determined to be incorrect by the determination unit is replaced with a wild card.

16. A non-transitory computer readable medium storing a program causing a computer to execute a process for processing information, the process comprising:
performing morphological analysis on a character recognition result;
generating a feature-value vector having elements, the number of which is P+1, for each character in the character recognition result, the feature-value vector including part-of-speech likelihoods and a character similarity for the character in the character recognition result, the part-of-speech likelihoods corresponding to P types of part of speech and being generated on the basis of a probability of a part of speech of a word which includes the character and which is the result of the morphological analysis; and
calculating a degree of certainty for each character in the character recognition result from the generated feature-value vector.

17. An information processing method comprising:
performing morphological analysis on a character recognition result;
generating a feature-value vector having elements, the number of which is P+1, for each character in the character recognition result, the feature-value vector including part-of-speech likelihoods and a character similarity for the character in the character recognition result, the part-of-speech likelihoods corresponding to P types of part of speech and being generated on the basis of a probability of a part of speech of a word which includes the character and which is the result of the morphological analysis; and
calculating a degree of certainty for each character in the character recognition result from the generated feature-value vector.
